(19) United States
(12) Patent Application Publication
(10) Pub. No.: US 2011/0273112 A1
(43) Pub. Date: Nov. 10, 2011

(54) LIGHT EMITTING DRIVER

(75) Inventors: Il Woon LEE, Seoul (KR); Tae Won LEE, Suwon (KR); Don Sik KIM, Gunpo (KR); Young Gun HONG, Hwaseong (KR); Dong Seong OH, Incheon (KR); Jin Wook KIM, Seoul (KR); Jong Hae KIM, Suwon (KR); Jae Sun WON, Suwon (KR)

(73) Assignee: SAMSUNG ELECTRO-MECHANICS CO., LTD., Suwon (KR)

(21) Appl. No.: 12/943,062

(22) Filed: Nov. 10, 2010

(30) Foreign Application Priority Data
May 7, 2010 (KR) 1020100043084

(51) Int. Cl. H05B 37/02

(52) U.S. Cl. 315/297; 315/307

(57) ABSTRACT

There is provided a light emitting driver. A light emitting driver according to an aspect of the invention may include: an LED driving section driving a light emitting part according to a detection value of the light emitting part including a plurality of light emitting devices; and a detection section transmitting the detection value to the LED driving section according to a detection voltage corresponding to a magnitude of a driving current flowing through the light emitting part when an output voltage, being applied to the light emitting part, has a value smaller than a predetermined output voltage reference value, and transmitting the detection value to the LED driving section according to a magnitude of the output voltage.

### CROSS-REFERENCE TO RELATED APPLICATIONS

This application claims the priority of Korean Patent Application No. 10-2010-0043084 filed on May 7, 2010, in the Korean Intellectual Property Office, the disclosure of which is incorporated herein by reference.

### BACKGROUND OF THE INVENTION

1. Field of the Invention

The present invention relates to a light emitting driver that can be applied to a light emitting system such as an LED, and more particularly, to a light emitting driver that performs constant current control on the basis of currents flowing through a light emitting part and drives the light emitting part by performing constant voltage control on the basis of an output voltage when the output voltage, being applied to the light emitting part, is suddenly increased to a high voltage.

2. Description of the Related Art

In general, an LED constant current control driving scheme is one of the most widely used LED driving schemes in association with high-efficiency LED driver circuits.

However, according to this constant current control driving scheme, when an LED device is removed, feedback information, which is supposed to be input to a controller, no longer exists. As a result, an LED driver circuit fails to enter a mode, which is set at the time of design, and an output voltage of the LED driver circuit is sharply increased.

As such, when the output voltage of an LED driver, which is input to the LED device, is increased, the LED driver is damaged and does not operate even when the LED device is re-mounted.

In order to solve these problems, an over voltage protection circuit may be provided in an LED driver.

However, in the case that this over voltage protection circuit is used, the LED driver is latched off by the operation of the over voltage protection circuit as soon as the LED device being mounted thereon is removed by a user in order to replace the LED device being mounted with a new one while the LED device is turned on.

In this case, in order to cause the LED driver to be operated again, an AC power cord is removed and subsequently reinserted so as to reset the LED driver.

That is, an LED driver circuit using a constant current control method necessarily uses an over voltage protection circuit in order to ensure safety and prevent component damage caused by an over voltage in an LED driver when the LED device is removed. The principle thereof will be explained as follows.

When an LED device is removed, if an output voltage is increased and reaches a predetermined voltage, an LED driver is latched off (turned off). Even when the LED device is re-mounted on the LED driver, having already been latched off, the LED device is not turned on.

Here, in order to turn on the LED device again, the LED driver being latched off needs to be reset. To this end, an AC power cord needs to be removed therefrom and reinserted. This inconvenience inhibits the supply of LED devices.

### SUMMARY OF THE INVENTION

An aspect of the present invention provides a light emitting driver that performs constant current control on the basis of currents flowing through a light emitting part and drives the light emitting part by performing current voltage control on the basis of an output voltage when the output voltage, being applied to the light emitting part, is suddenly increased to a high voltage.

According to an aspect of the present invention, there is provided a light emitting driver including: an LED driving section driving a light emitting part according to a detection value of the light emitting part including a plurality of light emitting devices; and a detection section transmitting the detection value to the LED driving section according to a detection voltage corresponding to a magnitude of a driving current flowing through the light emitting part when an output voltage, being applied to the light emitting part, has a value smaller than a predetermined output voltage reference value, and transmitting the detection value to the LED driving section according to a magnitude of the output voltage.

The light emitting driver may further include a current detection section detecting the detection voltage corresponding to the magnitude of the driving current flowing through the light emitting part and providing the detection voltage to the detection section.

The detection section may include: a first comparator unit comparing the detection voltage with a detection voltage reference value to thereby output a first error voltage; a second comparator unit comparing the output voltage with the predetermined output voltage reference value to thereby output a second error voltage; a low-voltage selection unit selecting a lower error voltage between the first error voltage and the second error voltage; and a transmission unit transmitting the detection value according to the magnitude of the lower error voltage, selected by the low-voltage selection unit, to the LED driving section.

The current detection section may include a sensing resistor connected between a cathode terminal of the light emitting part and a ground.

The first comparator unit may include: a first error amplifier having an inverting input terminal receiving the detection voltage, a non-inverting input terminal receiving the detection voltage reference value, and an output terminal outputting the first error voltage corresponding to a voltage difference between the detection voltage and the detection voltage reference value; and a first compensator connected between the inverting input terminal and the output terminal of the first error amplifier in order to increase the response time of the first error amplifier.

The second comparator unit may include: a converter converting the output voltage at a predetermined ratio; a second error amplifier having an inverting input terminal receiving a converted voltage from the converter, a non-inverting input terminal receiving the output voltage reference value, and an output terminal outputting a second error voltage corresponding to the voltage difference between the converted voltage and the detection voltage reference value; and a second comparator connected between the input terminal and the output terminal of the second error amplifier.

The low-voltage selection unit may include: a first diode having a cathode connected to the output terminal of the first comparator unit and an anode connected to the transmission unit; and a second diode having a cathode connected to both the output terminal of the second comparator unit and the transmission unit and having an anode connected to the anode of the first diode.

The transmission unit may include: a light emitting diode having an anode connected to a predetermined operating voltage terminal through a bias resistor and a cathode connected to an output terminal of the low-voltage selection unit; and a photo transistor having a base receiving light from the light emitting diode and a collector and an emitting connected to the LED driving section.

The light emitting part may include a plurality of LEDs.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram illustrating a light emitting driver according to an exemplary embodiment of the present invention;

FIG. 2 is a detailed circuit block diagram illustrating a detection section;

FIG. 3 is a graph illustrating an output voltage and a driving current when an LED is removed in the related art;

FIG. 4 is a graph illustrating an output voltage and a driving current when an LED is removed according to an exemplary embodiment of the present invention; and

FIG. 5 is a view exemplifying an actuation application of light emitting drivers according to an exemplary embodiment of the present invention.

### DETAILED DESCRIPTION OF THE PREFERRED EMBODIMENT

Exemplary embodiments of the present invention will now be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

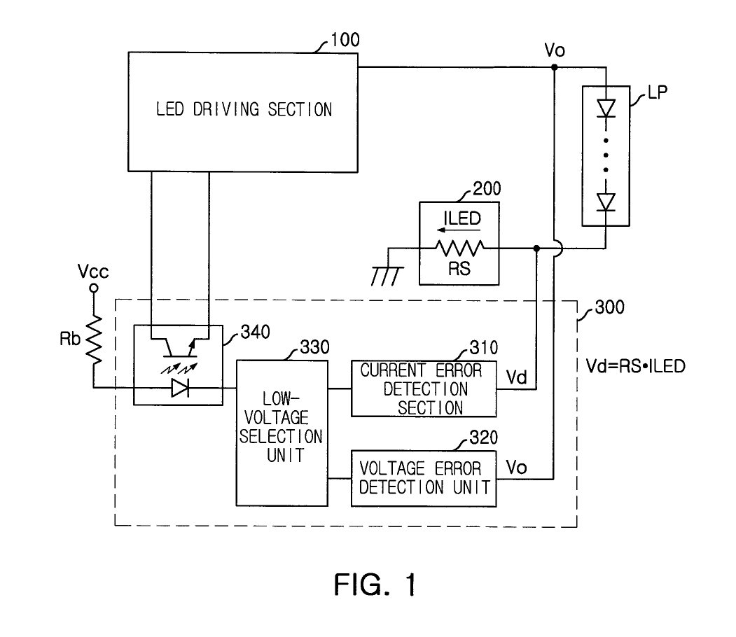

FIG. 1 is a block diagram illustrating a light emitting driver according to an exemplary embodiment of the invention.

Referring to FIG. 1, a light emitting driver according to this embodiment may include an LED driving section 100 and a detection section 300. The LED driving section 100 drives a light emitting part LP including a plurality of light emitting devices according to a detection value of the light emitting part LP. The detection section 300 transmits the detection value to the LED driving section 100 according to a detection voltage Vd corresponding to the magnitude of a driving current ILED, flowing through the light emitting part LP, when an output voltage Vo, being applied to the light emitting part LP, has a value smaller than a predetermined output voltage reference value Voref, and transmits the detection value to the LED driving section 100 according to the magnitude of the output voltage Vo when the output voltage Vo has a value greater than the output voltage reference value Voref.

Furthermore, the light emitting driver may further include a current detection section 200 that detects the detection voltage Vd corresponding to the magnitude of the driving current ILED flowing through the light emitting part LP and supplies the detection voltage Vd to the detection section 300.

Here, the current detection section 200 may include a sensing resistor RS that is connected between a cathode terminal of the light emitting part LP and a ground.

The detection section 300 includes a first comparator unit 310 that compares the detection voltage Vd with a predetermined detection voltage reference value Vdref to thereby output a first error voltage Vderr, a second comparator unit 320 that compares the output voltage Vo with a predetermined output voltage reference value Voref to thereby output a second error voltage Voerr, a low-voltage selection unit 330 that selects a lower error voltage between the first error voltage Vderr and the second error voltage Voerr, and a transmission unit 340 that transmits the detection value corresponding to the magnitude of the lower error voltage, selected by the low-voltage selection unit 330, to the LED driving section 100.

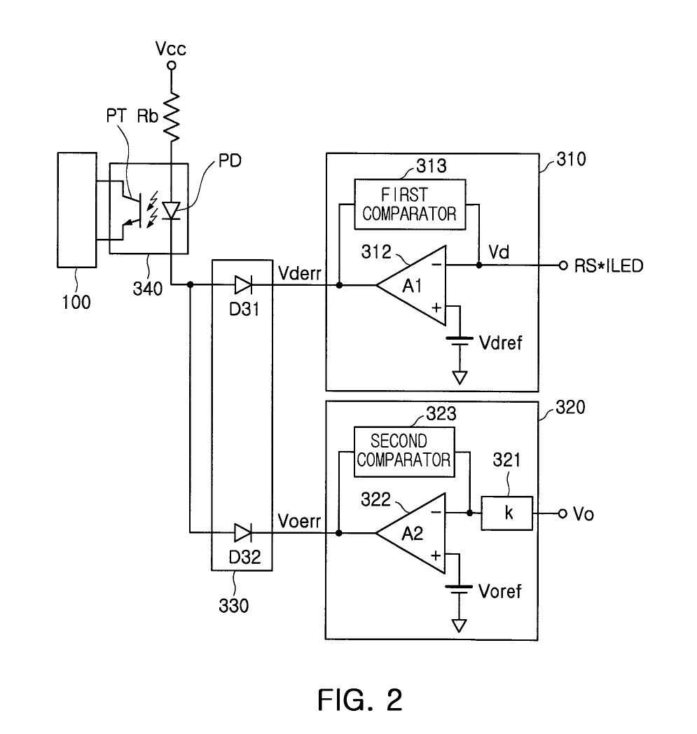

FIG. 2 is a detailed circuit block diagram illustrating a detection section according to an exemplary embodiment of the invention.

Referring to FIGS. 1 and 2, the first comparator unit 310 may include a first error amplifier 312 and a first compensator 313. The first error amplifier 312 has an inverting input terminal receiving the detection voltage Vd, a non-inverting input terminal receiving the detection voltage reference value Vdref, and an output terminal outputting the first error voltage Vderr corresponding to a voltage difference between the detection voltage Vd and the detection voltage reference value Vdref. The first compensator 313 is connected between the inverting input terminal and the output terminal of the first error amplifier 312 in order to increase the response time of the first error amplifier 312.

Furthermore, referring to FIGS. 1 and 2, the second comparator unit 320 may include a converter 321, a second error amplifier 322, and a second compensator 323. The converter 321 converts the output voltage Vo at a predetermined ratio k. The second error amplifier 322 has an inverting input terminal receiving a converted voltage from the converter 321, a non-inverting input terminal receiving the output voltage reference value Voref, and an output terminal outputting the second error voltage Voerr corresponding to a voltage difference between the converted voltage and the detection voltage reference value Vdref. The second compensator 323 is connected between the inverting input terminal and the output terminal of the second error amplifier 322 in order to increase the response time of the second error amplifier 322.

Furthermore, referring to FIGS. 1 and 2, the low-voltage selection unit 330 may include a first diode D31 and a second diode D32. The first diode D31 has a cathode connected to the output terminal of the first comparator unit 310 and an anode connected to the transmission unit 340. The second diode D32 has a cathode connected to the output terminal of the second comparator unit 320 and an anode connected to both the transmission unit 340 and the anode of the first diode D31.

The transmission unit 340 may include a light emitting diode PD and a photo transistor PT. The light emitting diode PD has an anode connected to a predetermined operating voltage Vcc terminal through the bias resistors Rb, and a cathode connected to the output terminal of the low-voltage selection unit 330. The photo transistor PT has a base receiving light from the light emitting diode PD, and a collector and an emitter connected to the LED driving section 100.

The light emitting part LP, to which the present invention is applied, includes devices emitting light, for example, a plurality of LEDs.

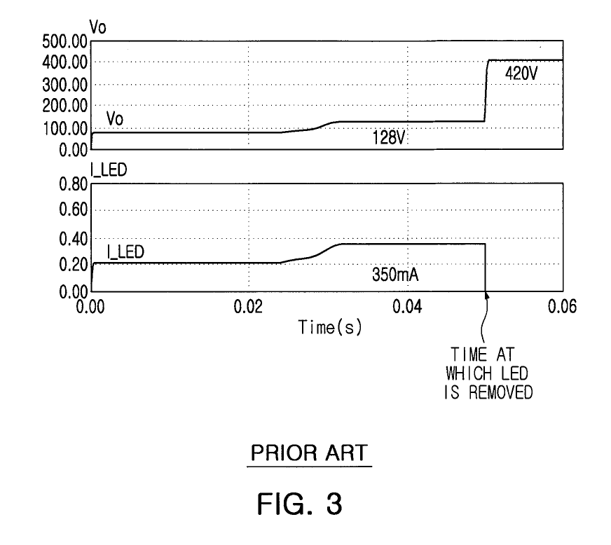

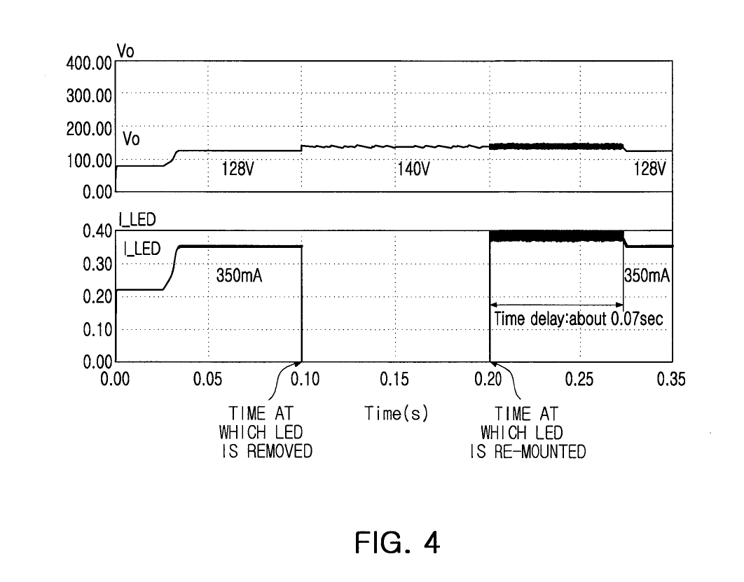

FIG. 3 is a graph showing an output voltage and a driving current when an LED is removed in the related art. FIG. 4 is a graph showing an output voltage and a driving current when an LED is removed according to an exemplary embodiment of the invention.

In the graph, illustrated in FIG. 3, when a light emitting driver according to the related art has a light emitting part including a plurality of LEDs connected in series with each other, if at least one LED is removed from the plurality of LEDs, the output voltage is shown to be increased to a considerably high voltage of, for example, 420V.

On the other hand, in the graph, illustrated in FIG. 4, when a light emitting driver according to an exemplary embodiment has a light emitting part including a plurality of LEDs connected in series with each other, if at least one LED is removed from the plurality of LEDs, an output voltage is shown not to be increased to an over voltage but to be maintained at a voltage of, for example, 140V.

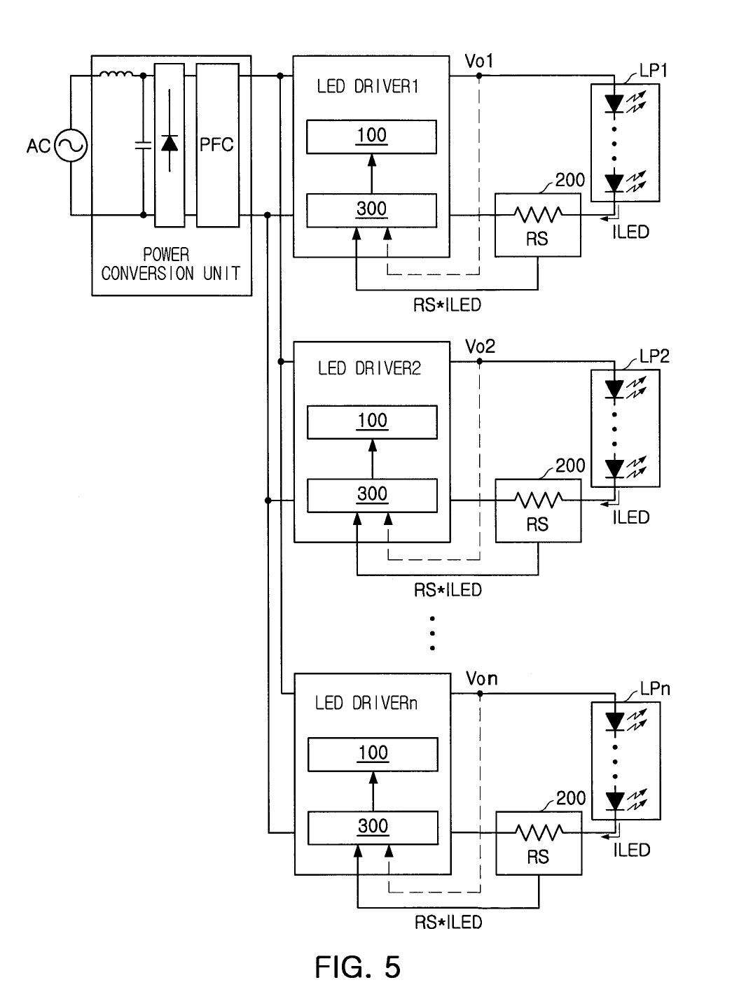

FIG. 5 is a view exemplifying an actual application including light emitting drivers according to an exemplary embodiment. FIG. 5 illustrates a case in which a plurality of light emitting drivers are connected in parallel with each other.

The operation and effects of the invention will be described with reference to the accompanying drawings.

A light emitting driver according to an exemplary embodiment of the invention will now be described with reference to FIGS. 1 through 5. First, in FIG. 1, the light emitting driver according to this embodiment includes the LED driving section 100. The LED driving section 100 drives the light emitting part LP according to a detection value of the light emitting part LP including plurality of light emitting devices.

As such, while the light emitting part LP is driven by the LED driving section 100, the detection section 300 transmits the detection value to the LED driving section 100 according to a detection voltage Vd corresponding to the magnitude of a driving current ILED flowing through the light emitting part LP when an output voltage Vo, being applied to the light emitting part LP, has a value smaller than a predetermined output voltage reference value Voref, and transmits the detection value to the LED driving section 100 according to the magnitude of the output voltage Vo when the output voltage Vo has a value greater than the output voltage reference value Voref.

Furthermore, the light emitting driver may further include the current detection section 200 that detects the detection voltage Vd corresponding to the magnitude of the driving current ILED, flowing through the light emitting part LP, and supplies the detection voltage Vd to the detection section 300.

More specifically, the current detection section 200 may include the sensing resistor RS. In this case, the current detection section 200 supplies a detection voltage (Vd=RS·ILED), which is determined by the driving current ILED, flowing through the light emitting part LP, and the sensing resistor RS, to the detection section 300.

Also, referring to FIG. 1, the detection section 300 may include the first comparator unit 310, the second comparator unit 320, the low-voltage selection unit 330, and the transmission unit 340.

Here, the first comparator unit 310 may compare the detection voltage Vd with the predetermined detection voltage reference value Vdref to thereby output the first error voltage Vderr to the low-voltage selection unit 330.

The second comparator unit 320 may compare the output voltage Vo with the output voltage reference value Voref to thereby output the second error voltage Voerr to the low-voltage selection unit 330.

The low-voltage selection unit 330 selects a lower error voltage between the first error voltage Vderr and the second error voltage Voerr and transmits the selected error voltage to the transmission unit 340.

The transmission unit 340 may transmit the detection value according to the magnitude of the error voltage, selected by the low-voltage selection unit 330, to the LED driving section 100.

In the case that the first comparator unit 310, the second comparator unit 320, the low-voltage selection unit 330, and the transmission unit 340 are configured as described in FIG. 2, they will be described in detail with reference to FIGS. 1 and 2.

In FIG. 2, the first error amplifier 312 of the first comparator unit 310 outputs the first error voltage Vderr through the output terminal. Here, the first error voltage Vderr corresponds to the voltage difference between the detection voltage Vd, being input through the inverting input terminal, and the detection voltage reference value Vdref, being input through the non-inverting input terminal.

For example, the first error voltage Vderr becomes a negative (−) voltage having a magnitude corresponding to the voltage difference when the detection voltage Vd has a value greater than the detection voltage reference value Vdref, and otherwise becomes a positive (+) voltage having a magnitude corresponding to the voltage difference.

Here, the first compensator 313, which is connected between the inverting input terminal and the output terminal of the first error amplifier 312, is provided in order to increase the response time of the first error amplifier 312.

Referring to FIG. 2, the second error amplifier 322 of the second comparator unit 320 outputs the second error voltage Voerr through the output terminal thereof. Here, the second error voltage Voerr corresponds to the voltage difference between the converted voltage, being converted by the converter 321 at the predetermined ratio k and being input through the inverting input terminal, and the output voltage reference value Voref, being input through the non-inverting terminal.

For example, the second error voltage Voerr becomes a negative (−) voltage having the magnitude corresponding to the voltage difference when the detection voltage Vd has a value greater than the detection voltage reference value Vdref, and otherwise becomes a positive (+) voltage having the magnitude corresponding to the voltage difference.

Here, the second compensator 323, which is connected between the inverting input terminal and the output terminal of the second error amplifier 322, is provided in order to improve the response time of the second error amplifier 322.

Furthermore, referring to FIGS. 1 and 2, one of the first diode D31 and the second diode D32 of the low-voltage selection unit 330 is turned on by a relatively smaller voltage between the first error voltage Vderr of the output terminal of the first comparator unit 310 and the second error voltage Voerr of the output terminal of the second comparator unit 320.

For example, when the first error voltage Vderr has a value smaller than the second error voltage Voerr, the first diode D31 is turned on and the first error voltage Vderr is selected. On the other hand, when the second error voltage Voerr has a value smaller than the first error voltage Vderr, the second diode D32 is turned on and the second error voltage Voerr is selected.

That is, according to the above-described operations of the first diode D31 and the second diode D32, a relatively lower voltage is selected between the first error voltage Vderr of the first comparator unit 310 and the second error voltage Voerr of the second comparator unit 320.

That is, during a normal operation in which LED devices are mounted, since the converted voltage has a value lower than the detection voltage reference value, the output of the second error amplifier becomes a high voltage, so that the second diode D32 is turned off. On the other hand, the first diode D31 is turned, and the LED driver is thereby controlled so that the detection voltage is used as a detection voltage reference value by the first error amplifier.

For example, when the LED devices are not mounted, the driving current ILED becomes zero, the output of the first error amplifier becomes a high voltage, and the first diode D1 is turned off. Then, the output voltage Vo is increased. When the converted voltage has a value corresponding to the output voltage reference value, the second diode D32 is turned on to thereby control the LED driver so that the value of the converted voltage becomes equal to the output voltage reference value.

In other words, when an LED device is mounted, constant current control is made by the first error amplifier and the first diode D31. When an LED is not mounted, constant current control is made by the second error amplifier and the second diode D32.

The LED driver simulation results to which the above-described operating principle is applied are shown in FIG. 4. An LLC resonant circuit was used as an LED driver power stage for simulation.

The transmission unit 340 may be configured as a photocoupler. Here, a current corresponding to the magnitude of the voltage difference between an anode, connected to the predetermined operating voltage Vcc terminal through the bias resistors Rb, and a cathode connected to the output terminal of the low-voltage selection unit 330, flows through the light emitting diode PD of the photocoupler.

That is, since the operating voltage Vcc is fixed, the lower the voltage is selected by the low-voltage selection unit 330, the higher current flows through the higher currents light emitting diode PD. Light corresponding to the magnitude of this current is transmitted to a base of a photo transistor of the photocoupler, and finally to the LED driving section 100. The light emitting part LP can be driven according to the intensity of the light being received by the phototransistor.

In the graph, illustrated in FIG. 3, when a light emitting driver according to the related art has a light emitting part including a plurality of LEDs connected in series with each other, if at least one LED is removed from the plurality of LEDs, the output voltage is shown to be increased to a considerably high voltage of, for example, 420V.

On the other hand, in the graph, illustrated in FIG. 4, when a light emitting driver according to an exemplary embodiment of the invention has a light emitting part including a plurality of LEDs connected in series with each other, if at least one LED is removed from the plurality of LEDs, an output voltage is shown not to be increased to an over voltage but to be maintained at a temperature of, for example, 140V.

That is, as shown in FIG. 4, according to an exemplary embodiment of the invention, when an LED device is removed during operation, the output voltage is not rapidly increased. Furthermore, while the LED driver is not latched off, the output voltage is controlled at a predetermined voltage of, for example, 140V. Here, the removal of the LED device can be confirmed by the fact that a current I_LED has reached zero. When the LED device is mounted again, the LED driver is returned to a normal state of 128V/350 mA for a very short delay time, that is, 0.07 sec.

FIG. 5 is a view exemplifying an actual application including light emitting drivers according to an exemplary embodiment. FIG. 5 illustrates a case in which a plurality of light emitting drivers according to an exemplary embodiment of the invention are connected in parallel with each other.

As described above, a method according to an exemplary embodiment of the invention relates to a method of controlling an LED driver circuit. By adding constant voltage control to a constant current control scheme of an existing LED driver circuit, constant current control is performed when an LED is mounted and turned on, and constant current control is performed when an LED is not mounted, so that a user does not have to reset the LED driver circuit when replacing an LED and the like. Furthermore, the added constant voltage control provides protection against risks such as fires or explosions to an LED driver under undesirable occurrence such as circuit malfunction or component damage. The present invention is regarded as an essential technique to promote the widespread use of LEDs.

As set forth above, according to exemplary embodiments of the invention, while constant current control, based on currents flowing through a light emitting part, is carried out, if an output voltage, being applied to the light emitting part, is suddenly increased to a high voltage, the light emitting part can be driven by performing the constant voltage control based on the output voltage, so that it is possible to remove and replace an LED device during the operation of the LED driver. Furthermore, even when an open failure is caused by damage to an LED device, damage to the LED driver caused by a rapid increase in voltage can be prevented by the operation of a constant voltage loop. Moreover, by replacing the LED device with a new one, the LED driver is immediately returned to a normal constant current mode. In addition, risks such as fires or explosions, are not caused because of constant current and constant voltage control, and user convenience can be provided to general users using an LED lighting system mounted with LED drivers.

While the present invention has been shown and described in connection with the exemplary embodiments, it will be apparent to those skilled in the art that modifications and variations can be made without departing from the spirit and scope of the invention as defined by the appended claims.

What is claimed is:

1. A light emitting driver comprising:
an LED driving section driving a light emitting part according to a detection value of the light emitting part including a plurality of light emitting devices; and
a detection section transmitting the detection value to the LED driving section according to a detection voltage corresponding to a magnitude of a driving current flowing through the light emitting part when an output voltage, being applied to the light emitting part, has a value smaller than a predetermined output voltage reference value, and transmitting the detection value to the LED driving section according to a magnitude of the output voltage.

2. The light emitting driver of claim 1, further comprising a current detection section detecting the detection voltage corresponding to the magnitude of the driving current flowing through the light emitting part and providing the detection voltage to the detection section.

3. The light emitting driver of claim 2, wherein the detection section comprises:
a first comparator unit comparing the detection voltage with a detection voltage reference value to thereby output a first error voltage;
a second comparator unit comparing the output voltage with the predetermined output voltage reference value to thereby output a second error voltage;
a low-voltage selection unit selecting a lower error voltage between the first error voltage and the second error voltage; and
a transmission unit transmitting the detection value according to the magnitude of the lower error voltage, selected by the low-voltage selection unit, to the LED driving section.

4. The light emitting driver of claim 3, wherein the current detection section comprises a sensing resistor connected between a cathode terminal of the light emitting part and a ground.

5. The light emitting driver of claim 4, wherein the first comparator unit comprises:
a first error amplifier having an inverting input terminal receiving the detection voltage, a non-inverting input terminal receiving the detection voltage reference value, and an output terminal outputting the first error voltage corresponding to a voltage difference between the detection voltage and the detection voltage reference value; and
a first compensator connected between the inverting input terminal and the output terminal of the first error amplifier in order to increase the response time of the first error amplifier.

6. The light emitting driver of claim 4, wherein the second comparator unit comprises:
a converter converting the output voltage at a predetermined ratio;
a second error amplifier having an inverting input terminal receiving a converted voltage from the converter, a non-inverting input terminal receiving the output voltage reference value, and an output terminal outputting a second error voltage corresponding to the voltage difference between the converted voltage and the detection voltage reference value; and
a second comparator connected between the input terminal and the output terminal of the second error amplifier.

7. The light emitting driver of claim 4, wherein the low-voltage selection unit comprises:
a first diode having a cathode connected to the output terminal of the first comparator unit and an anode connected to the transmission unit; and
a second diode having a cathode connected to both the output terminal of the second comparator unit and the transmission unit and having an anode connected to the anode of the first diode.

8. The light emitting driver of claim 4, wherein the transmission unit comprises:
a light emitting diode having an anode connected to a predetermined operating voltage terminal through a bias resistor and a cathode connected to an output terminal of the low-voltage selection unit; and
a photo transistor having abase receiving light from the light emitting diode and a collector and an emitting connected to the LED driving section.

9. The light emitting driver of claim 1, wherein the light emitting part comprises a plurality of LEDs.
